(19) United States
(12) Patent Application Publication
(10) Pub. No.: US 2022/0028417 A1
(43) Pub. Date: Jan. 27, 2022

(54) WAKEWORD-LESS SPEECH DETECTION

(71) Applicant: Horaizon Corporation, Brooklyn, NY (US)

(72) Inventors: William Alphonsus Mitchell, Hamden, CT (US); Nathanael Jacob-Rene Ngbondo Koweda, Seattle, WA (US)

(21) Appl. No.: 17/384,315

(22) Filed: Jul. 23, 2021

Related U.S. Application Data
(60) Provisional application No. 63/055,479, filed on Jul. 23, 2020.

(51) Int. Cl. G10L 25/78; G10L 25/54; H04L 29/06

(52) U.S. Cl. CPC G10L 25/78; H04L 65/60; G10L 25/54

(57) ABSTRACT

A network, communications unit, and method employed for wakeword-less speech communication are disclosed, where a user's intent to talk with another user in a group may be accomplished without the use of a wakeword. These could include a network platform; and a plurality of communication units, each being comprised of a microphone, a speaker, and a processor, the latter being configured to receive speech data representative of audio spoken by the user; buffer the speech data; apply intent recognition of the buffered speech data including the use of natural language processing (NLP); open one or more audio communication channels based upon the application of intent recognition; receive speech data through one or more audio communication channels responsive to the buffered speech data; apply intent recognition to the received speech data; and close one or more audio communication channels based upon the application of second intent recognition.

### CROSS-REFERENCE TO RELATED APPLICATION

This application claims the benefit of U.S. Provisional Patent Application Ser. No. 63/055,479, filed Jul. 23, 2020, which is incorporated by reference herein in its entirety.

### BACKGROUND

Systems involving voice activation often employ “wakewords” which are words of phrases that causes a device to begin an operation such as recording a user's request. The wakeword “awakens” a device into performing an operation. Once recorded, the wakeword could be forwarded to a server of a local network or a networking cloud for analysis and processing.

For example, a product “smart speaker” such as Amazon Echo sold by Amazon.com, Inc. employs the use of wakewords. Once a wakeword is spoken, it begins to record the next spoken request and sends the recording to the cloud of Amazon Web Services (AWS) for further processing responsive to the content of the recording. In such a system, the wakeword is known because it has been predefined.

### SUMMARY

Embodiments of the inventive concepts disclosed herein are directed to a network, a communications unit, and a method for employing wakeword-less speech communication. These could be employed to record a user's request without the need for a predefined wakeword.

In one aspect, embodiments of the inventive concepts disclosed herein are directed to a wakeword-less speech communication network. The communication network could include a network platform and a group or plurality of communication units communicatively connected to the platform. Each communication unit could include a microphone, a speaker, and a processing unit (PU) configured to perform the method disclosed in the second paragraph that follows.

In a further aspect, embodiments of the inventive concepts disclosed herein are directed to a communications unit employed in a wakeword-less speech communication network. The device could be comprised of the PU configured to perform the method disclosed in the paragraph that follows.

In a further aspect, embodiments of the inventive concepts disclosed herein are directed to a method for employing wakeword-less speech in a wakeword-less speech communication network. When properly configured, the PU could receive first speech data representative of first audio from a first user of a plurality of users; buffer the first speech data; apply first intent recognition to the buffered first speech data; and open one or more audio communication channels based upon the application of first intent recognition. Additionally, the PU could send the buffered first speech data through the one or more audio communication channels. Additionally, the PU could receive second speech data representative of second audio from the first user indicative of an intent to close the at least one audio communication channel; apply second intent recognition to the second speech data; send the second speech data through the one or more audio communication channels; and close one or more audio communication channel(s) based upon the application of second intent recognition speech data.

### BRIEF DESCRIPTION OF THE DRAWINGS

For a fuller understanding of the inventive embodiments, reference is made to the following description taken in connection with the accompanying drawings in which:

FIG. 1A illustrates a wakeword-less speech processing network, in accordance with some embodiments;

FIG. 1B illustrates a user's communication unit, in accordance with some embodiments;

FIG. 1C illustrates a processing unit, in accordance with some embodiments;

FIG. 2A illustrates one employment of an intent recognition module, in accordance with some embodiments;

FIG. 2B illustrates a second employment of an intent recognition module, in accordance with some embodiments; and

FIG. 3 illustrates a method for employing wakeword-less speech processing, in accordance with some embodiments.

### DETAILED DESCRIPTION

In the following description, several specific details are presented to provide a thorough understanding of embodiments of the inventive concepts disclosed herein. One skilled in the relevant art will recognize, however, that embodiments of the inventive concepts disclosed herein can be practiced without one or more of the specific details, or in combination with other components, etc. In other instances, well-known implementations or operations are not shown or described in detail to avoid obscuring aspects of various embodiments of the inventive concepts disclosed herein.

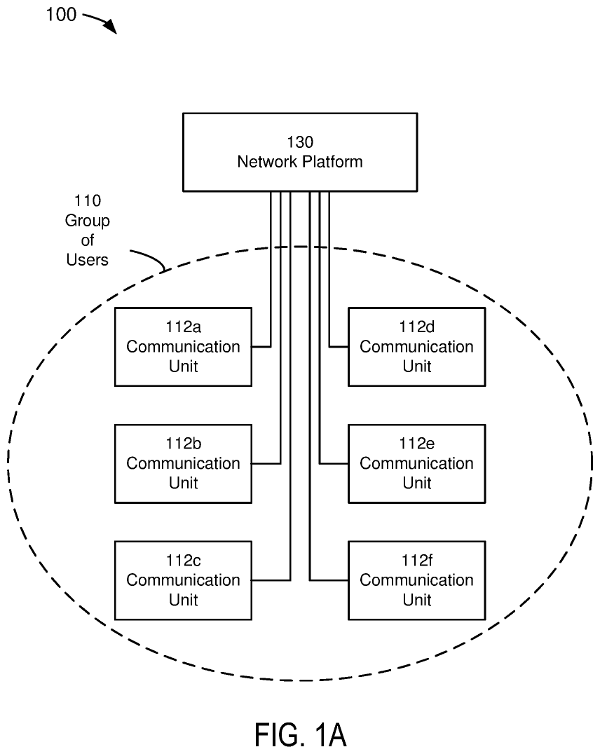

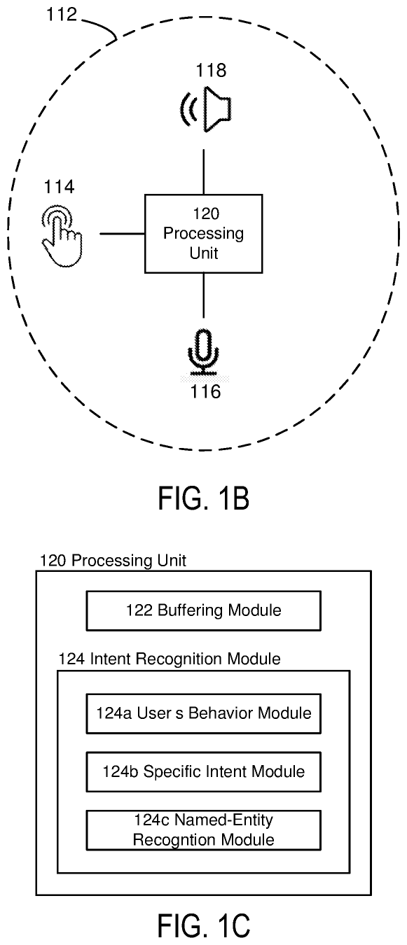

Referring now to FIGS. 1A through 1C, inclusive, an embodiment of an adaptive wakeword-less speech processing network 100 suitable for implementation of the inventive concepts described herein that may include a group of communication units 110 and a network platform 130.

Group of communication units 110 could include individual communication units 112a-112f, each of which may be used by a user. Each communication unit 112 may include an input device 114, a microphone 116, a speaker 118, and a processing unit (PU) 120. As shown, microphone 116, speaker 118, and PU 120 may be separate components electronically coupled in network 100 to perform the embodiments disclosed herein via wired and/or wireless communications. In some embodiments, microphone 116, speaker 118, and PU 120 may be housed in one component such as, but not limited to, a portable electronic devices (e.g., smart phones, tablets, wearables, laptops, etc. . . . ).

Input device 114 could be any interface which facilitates a user's ability to log on to network 100 and/or awaken it from a “sleep” mode. Common input devices include, but are not limited to, a mouse, keyboard, and touchscreen. In some embodiments, Input device 114 could employ an interface such as a graphical user interface (GUI) displayed to and selectable by the user. For example, the GUI could be part of an application or “app” that, when selected (e.g., tapped or clicked), communicatively connects to network 100 by establishing a wireless and/or wired communications between communication unit 112 and network platform 130. In some embodiments, wireless communications could be established over the internet and/or WiFi network. In some embodiments, wired communications could be established over a private network.

Microphone 116 could be configured to receive audio representative of human speech from a speaking user which will be provided to PU 120. Speaker 118 could be configured to present audio to a listening user, where the audio may be representative of data sent or streamed by network platform 130. It should be noted that the terms “sent” and “streamed” as well as the terms “send” and “stream” are synonymous. In some embodiments, the speaking user could also be the listening user once an audio communication channel has been opened.

It should be noted that the terms “programmed” and “configured” are synonymous. PU 120 and/or network platform 130 may each be electronically coupled or communicatively connected to facilitate the streaming and receiving of streaming data. In some embodiments, terms of electronically coupled and communicatively connected may be considered as interchangeable or synonymous with each together. It is not necessary that a direct connection be made; instead, streaming of audio could be provided through a bus, through a wireless network, or signal sent and/or streamed by PU 120 and/or network platform 130 via a physical or a virtual computer port. PU 120 and/or network platform 130 may be programmed to execute the method discussed in detail below.

Processing unit 120 may include a buffering module 122 and an intent recognition module 124. Buffering module 122 could be configured to temporally store data representative of the audio received by microphone 116. The amount of time necessary for the buffering the data may be determined as an amount of time necessary to determine the intent of the user as performed by intent recognition module 124. In many instances, the amount of time may just be a few seconds.

Buffering module 122 and/or intent recognition module 124 may be programmed with functionality that includes a sleep mode which, when entered into, could inhibit or disable the user's ability to interact with network 100 or open an audio communication channel within network 100 when a user's interaction with input device 114 and/or microphone 116 has not be detected for a set period of time. To enable the user's ability to interact with network 100 or open an audio communication channel within network 100, the user may be required to provide input through input device 114 and/or microphone 116. After the input has been provided, buffering module 122 and/or intent recognition module 124 may begin to function. In some embodiments, the sleep mode of PU 120 may be different than a separate sleep mode set for communications unit 112.

Intent recognition module 124 could include a user's behavior module 124a, a specific intent recognition module 124b, and a named entity recognition module 124c that may be used to determine the intent of the user. In some embodiments, user's behavior module 124a may be performed in parallel with or before the performance of entity recognition module 124b and intent recognition module 124c.

User's behavior module 124a may include instructions to determine the user's behavior as a function of, but not limited to, a user's unique speech pattern known to network 100. Characteristics of speech patterns include, but are not limited to, inflection (e.g., uptalk, intonation contours, rhythm, prosody, etc. . . . ), speech rate, clarity, brevity, and emotive mood. In some embodiments, the user's speech pattern as more is learned from his or her usage. For the purpose of illustration, prosody may include measurements of pitch, volume, rhythm, and tempo. In some embodiments, thresholds may be set for these measurements such that, if a minimum threshold has not been met, then it will not be able to recognize or determine the user's intent.

Specific intent recognition module 124b may include instructions to recognize the speaker's specific intent as a function of natural language processing (NLP). In general, NLP refers to a branch of computer science or artificial intelligence (AI) concerned with giving computers the ability to, in part, understand spoken words. Known to those skilled in the art, NLP performs tasks including, but not limited to, speech recognition, speech tagging, word sense disambiguation, and sentimental analysis.

Named entity recognition module 124c may include instructions to recognize a name(s) of the users known to or identified by network 100 that have been spoken by the speaking user. In some embodiments, the known or identified users could be stored in user's communications unit 110 and loaded by the app when the user logs on. In some embodiments, the known or identified users could be provided in streamed data by network platform 130, where the known or identified users could be those users currently logged on to network 100 and/or all of the users belonging to network 100.

If the results from user's behavior module 124a, specific intent recognition module 124b, and named entity recognition module 124c indicate a user's desire to speak to another user(s) identified or named by the user as determined by the named entity recognition module 124c, PU 130 could be instructed to open an audio communication channel(s) and send the buffered speech data through the communication channel(s), such that the identified or named user may hear the audio represented in the buffered speech data after network platform 130 establishes a communicative connection.

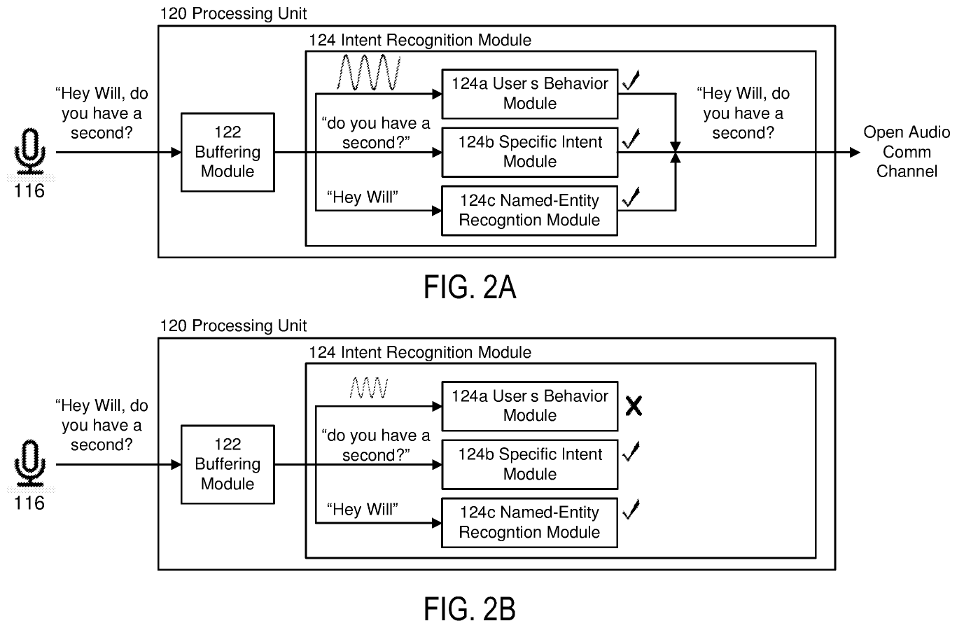

Referring now to FIGS. 2A and 2B, two examples are presented to illustrate how an audio communications channel may be opened using intent recognition module 124. As shown in FIG. 2A, a user has spoken the phrase “Hey Will do you have a moment?” After being received by 120 PU from microphone 116 and buffered by buffering module 122, the phrase is subjected to intent recognition module 124. Using a sine wave to represent the user's speech pattern, user's behavior module 124a has recognized the speech pattern as an expression of user's intent as shown by the checkmark; that is, the user is expressing an intent to speak to another. When the phase is subjected to specific intent recognition module 124b and named entity recognition module 124c, the user's specific intent expressed in “do you have a moment” is recognized by the former and the user's name to which the user's intent is directed in recognized by the latter as shown by the respective checkmarks. Because intent recognition module 124 has determined that the user has expressed an intent to speak to a named individual, PU 120 has opened an audio channel to communicatively connect with the named person.

As shown in FIG. 2B, the same phrase is being subjected to intent recognition module 124. When compared with the sine wave of FIG. 2A, the sine wave of FIG. 2B has a smaller amplitude. For the purpose of illustration, this will indicate a change in prosody of the user's speech pattern which will not meet a minimum threshold as discussed above. With this user's speech pattern is subjected to user's behavior module 124a, the speech pattern has not been recognized as an expression of user's intent as shown by the X mark. As such, an audio channel has not been opened by PU 120.

It should be noted that, although the user's intent of preceding examples used one person's name, named entity recognition module 124c may be programmed to recognize more than one name. As such, PU 120 may open more than one audio channel, each one to communicatively connect with one named person.

Returning now to FIGS. 1A through 1C, inclusive, network platform 130 may be part of, but not limited to, a cloud computing platform or a server of a local network. Network platform 130 may include instructions to establish a communicative connection between communication unit 110 of the user and the communication unit(s) 110 of the identified or named user(s) when PU 130 has opened the audio communication channel(s). Once the communication connection has been established, the buffered speech data may be received from communication unit 110 of the user and provided to communication unit(s) 110 of the identified or named user(s) through network platform 130.

In some embodiments, PU 120 and/or network platform 130 may include any electronic data processing unit which executes software or source code stored, permanently or temporarily, in a digital memory storage device and/or a non-transitory processor-readable medium storing processor-executable code. PU 120 and/or network platform 130 may be driven by the execution of software or source code containing algorithms developed for the specific functions embodied herein. Common examples of electronic data processing units are microprocessors, Digital Signal Processors, Programmable Logic Devices, Programmable Gate Arrays, and signal generators; however, for the embodiments herein, the terms processor and platform are not limited to such processing units and its meaning is not intended to be construed narrowly. For instance, a processor could also include more than one electronic data processing units.

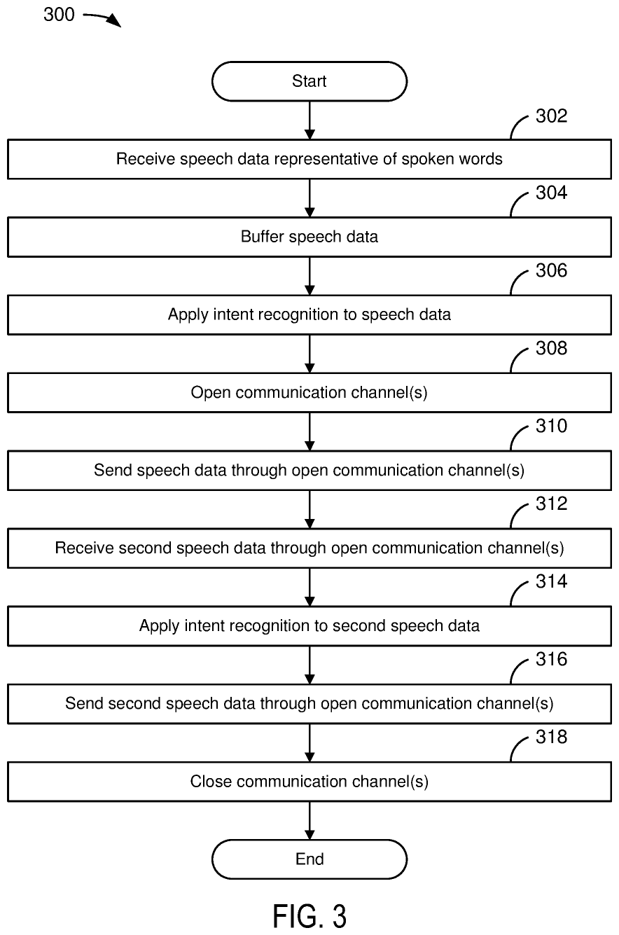

Referring now to FIG. 3, flowchart 300 is presented to disclose an example of a method for employing wakeword-less speech communication, where the PU 120 may be programmed or configured with instructions corresponding to the following modules embodied in the flowchart.

The method of flowchart 300 begins with module 302 with PU 120 receiving speech data representative of spoken words of a user, where the audio may be received through a microphone.

The method of flowchart 300 continues with module 304 with PU 120 performing buffering module 122 to buffer the speech data. In some embodiments, the speech data may be buffered as a function of the user's interactions with his or her communications device 110 and/or the behavior of a group of a plurality of users as discussed above.

The method of flowchart 300 continues with module 306 with PU 120 applying intent recognition module 124 to the speech data (or buffered speech data) to determine the user's intent through his or her spoken words. In some embodiments, user's behavior module 124a may be performed to determine the speaker's behavior; specific intent recognition module 124b may be performed to determine the speaker's specific intent as a function of at least NLP; and/or named entity recognition module 124c may be performed to determine or identify a name(s) of the users known to or identified by network 100 that have been spoken by the user. In some embodiments, user's behavior module 124a may be performed prior to specific intent recognition module 124b and named entity recognition module 124c to ensure the user's behavior is indicative of the user's desire to speak to another user through a communications channel; if the user does not want to speak to another user through a communications channel, then the performance of specific intent recognition module 124b and named entity recognition module 124c may be avoided.

The method of flowchart 300 continues with module 308 with PU 120 opening one or more audio communication channels based upon the results of the application of intent recognition module 124. In some embodiments, the one or more audio communication channels may be opened to communicatively connect with communication unit(s) 110 of the identified or named user(s) if the speaker's behavior, his or her specific intent, and other user(s) are identified or named in the buffer speech data indicate the speaker wants to speak to the identified or named user(s).

The method of flowchart 300 continues with module 310 with PU 120 sending the speech data (or buffered speech data) through the one or more opened audio communication channels, such that the buffered speech data is sent to communication unit 110 of each identified or named user(s).

The method of flowchart 300 continues with module 312 with PU 120 receiving second speech data representative of second audio from the first user and spoken words to indicate his or her intent to close the at least one audio communication channel. Phrases such as “can't talk now”, “got to go”, “goodbye”, and “see you later” are just a few examples to indicate the user's intent to end the conversation.

The method of flowchart 300 continues with module 314 with PU 120 applying intent recognition module 124 to the second speech data to determine the first user's intent through his or her spoken words.

The method of flowchart 300 continues with module 316 with sending the second speech data through the one or more opened audio communication channels.

The method of flowchart 300 continues with module 318 with PU 120 closing one or more audio communication channels if the results of the application of intent recognition module 124 indicates a user's desire to end the conversation. Then, the method of flowchart 300 ends.

It should be noted that the steps of the method described above may be embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A method for employing wakeword-less speech communication, comprising:
receiving, by a processing unit including at least one processor coupled to a non-transitory processor-readable medium storing processor-executable code, first speech data representative of first audio from a first user of a plurality of users;
buffering the first speech data;
applying first intent recognition to the first speech data; and
opening at least one audio communication channel based upon the application of first intent recognition, such that
a first communication unit of the first user is communicatively connected, through a network platform, with at least one second communication unit of a second user of the plurality of users.

2. The method of claim 1, wherein the buffering of the first speech data is determined as a function of at least one of a first user's interactions with the first communications unit and a behavior of the plurality of the users.

3. The method of claim 1, wherein the application of first intent recognition includes determining the first user's behavior.

4. The method of claim 3, wherein the first user's behavior is determined as a function of at least one of a duration of the first speech, distribution of pauses, and proximity to a microphone receiving the first speech.

5. The method of claim 3, wherein the application of first intent recognition further includes recognizing the first user's specific intent and a name of at least one user of the plurality of users.

6. The method of claim 1, further comprising:
sending the first speech data through the at least one audio communication channel.

7. The method of claim 6, further comprising:
receiving second speech data representative of second audio from the first user and indicative of the first user's intent to close the at least one audio communication channel;
applying second intent recognition to second speech data;
sending second speech data through the at least one audio communication channel; and
closing the at least one audio communication channel based upon the application of second intent recognition, such that
the first communication unit and the at least one second communication unit are communicatively disconnected.

8. A communication unit employing wakeword-less speech, comprising:
a processing unit of a first communications unit, including at least one processor coupled to a non-transitory processor-readable medium storing processor-executable code, configured to:
receive first speech data representative of first audio from a first user of a plurality of users;
buffer the first speech data;
apply first intent recognition to the buffered first speech data; and
open at least one audio communication channel based upon the application of first intent recognition, such that
the first communication unit of the first user is communicatively connected, through a network platform, with at least one second communication unit of a second user of the plurality of users.

9. The communication unit of claim 8, wherein the buffering of the first speech data is determined as a function of at least one of a first user's interactions with the first communications unit and a behavior of the plurality of the users.

10. The communication unit of claim 8, wherein the application of first intent recognition includes determining the first user's behavior.

11. The communication unit of claim 10, wherein the first user's behavior is determined as a function of at least one of a duration of the first speech, distribution of pauses, and proximity to a microphone receiving the first speech.

12. The communication unit of claim 10, wherein the application of first intent recognition further includes recognizing the first user's specific intent and a name of at least one user of the plurality of users.

13. The communication unit of claim 8, wherein
the processing unit is further configured to:
send the first speech data through the at least one audio communication channel.

14. The communication unit of claim 13, further comprising:
receive second speech data representative of second audio from the first user and indicative of the first user's intent to close the at least one audio communication channel;
apply second intent recognition to second speech data;
send second speech data through the at least one audio communication channel; and
close the at least one audio communication channel based upon the application of second intent recognition, such that
the first communication unit and the at least one second communication unit are communicatively disconnected.

15. A wakeword-less speech communication network, comprising:
a network platform; and
a plurality of communication units communicatively connected to the platform, where
each communication unit of the plurality of communication units is comprised of:
a microphone configured to receive first audio representative of speech of a first user of a plurality of users,
a speaker configured to present second audio representative of speech of at least one second user of the plurality of users, and
a processing unit, including at least one processor coupled to a non-transitory processor-readable medium storing processor-executable code, configured to:
receive first speech data representative of the first audio;
buffer the first speech data;
apply first intent recognition to the buffered first speech data; and
open at least one audio communication channel based upon the application of first intent recognition, such that
a first communication unit of the first user is communicatively connected, through the network platform, with at least one second communication unit of a second user of the plurality of users.

16. The communication network of claim 15, wherein the buffering of the first speech data is determined as a function of at least one of a first user's interactions with the first communications unit and a behavior of the plurality of the users.

17. The communication network of claim 15, wherein the application of first intent recognition includes determining the first user's behavior.

18. The communication network of claim 17, wherein the application of first intent recognition further includes recognizing the first user's specific intent and a name of at least one user of the plurality of users.

19. The communication network of claim 15, wherein
the processing unit is further configured to:
send the first speech data through the at least one audio communication channel.

20. The communication network of claim 13, further comprising:
receive second speech data representative of second audio from the first user and indicative of the first user's intent to close the at least one audio communication channel;
apply second intent recognition to second speech data;
send second speech data through the at least one audio communication channel; and
close the at least one audio communication channel based upon the application of second intent recognition, such that
the first communication unit and the at least one second communication unit are communicatively disconnected.
